(19) United States
(12) Patent Application Publication
(10) Pub. No.: US 2014/0157150 A1
(43) Pub. Date: Jun. 5, 2014

(54) CONTEXTUAL COLLABORATION

(71) Applicants: VIJAYA SARATHI DURVASULA, Bangalore (IN); SURESH HONNAPPANAVAR, Gadag (IN); ASHOK KUMAR M, Coimbatore (IN); RAVEESHKUMAR BHAT, Margao (IN); GANESH VISWANATHAN IYER, Mumbai (IN)

(72) Inventors: VIJAYA SARATHI DURVASULA, Bangalore (IN); SURESH HONNAPPANAVAR, Gadag (IN); ASHOK KUMAR M, Coimbatore (IN); RAVEESHKUMAR BHAT, Margao (IN); GANESH VISWANATHAN IYER, Mumbai (IN)

(21) Appl. No.: 13/691,851

(22) Filed: Dec. 3, 2012

(51) Int. Cl. H04L 12/58; G06F 3/0484

(52) U.S. Cl. CPC H04L 51/04; G06F 3/0484
USPC 715/753; 709/203

(57) ABSTRACT

Various embodiments of systems and methods for contextual collaboration are described herein. In one aspect, the method includes identifying an activated business instance. Conversation data related to the activated business instance is retrieved. The retrieved conversation data is integrated with the activated business instance. The integrated conversation data is rendered along with the activated business instance on a user interface.

### BACKGROUND

Most business tasks require interaction or collaboration between employees, e.g., for clarifying queries. The employees interact through various channels of communication such as mails, cell phones, social networking sites, communicators, etc. Usually, the communication channels are separated from a business system where the business task is performed. Therefore, the employee, performing the task, need to switch between the business system and the communication channels to refer to relevant communications related to the task or to clarify queries. However, it might be inconvenient and distracting to switch between the communication channels and business system while performing task. Further, switching between the communication channels and business system consumes time and affects productivity. Also, if a business task is associated with other business tasks then it might be required to aggregate relevant communications related to other business tasks as well, which again is a time consuming and tiring task.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system including a communication tool integrated with a business instance, according to an embodiment.

FIG. 2 illustrates the business instance, as an example.

FIG. 3 is a block diagram of various business instances associated with a business application, according to an embodiment.

FIG. 4 illustrates the business application integrated with a collaboration platform, according to an embodiment.

FIG. 5 illustrates the business instance of FIG. 2 integrated with the communication tool, according to an embodiment.

FIG. 6 illustrates the communication tool, according to an embodiment.

FIGS. 7A and 7B illustrate business processes that are associated with the business instance of FIG. 2, according to one embodiment.

FIG. 8 illustrates conversation data of the business processes of FIGS. 7A and 7B being displayed along with the business instance of FIG. 2, according to an embodiment.

FIG. 9 is a flow chart of a method for contextual collaboration, according to an embodiment.

FIG. 10 is a flow chart illustrating the steps to render conversation data related to business instances associated with the activated business instance, according to an embodiment.

FIG. 11 is a block diagram of an exemplary computer system, according to an embodiment.

### DETAILED DESCRIPTION

Embodiments of techniques for contextual collaboration are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A business object (130) describes a structure and behavior of a real-world object used during the transaction of business. For example, a business object may represent a business document such as a sales order, a purchase order, or an invoice. In one embodiment, the business object may represent items such as a product, a business partner, or a piece of equipment. Typically, a business object includes data and functions along with the data.

A business process may be a structure of functions or a series of activities that produce a specific result (e.g. a service or a product). In one embodiment, the series of activities may be a sequence of activities with interleaving decision points and may be visualized with a flowchart. In one embodiment, the series of activities may be executed simultaneously. In one embodiment, one or more business rules are associated with corresponding business processes. Typically, a business process is executed based upon the business rules to produce the specific result.

A business task may he a single action with a measurable result within a business process. Therefore, a business task is a subset of the business process. For example, if the business process is ‘change of working time’ then various business tasks associated with it may be ‘request for approving the change of working time’ (human task), ‘approve the change’ (human task), ‘verify the company policies and update a system based upon the change’ (human task), and ‘inform the employee and a manager about the changes’ (system task).

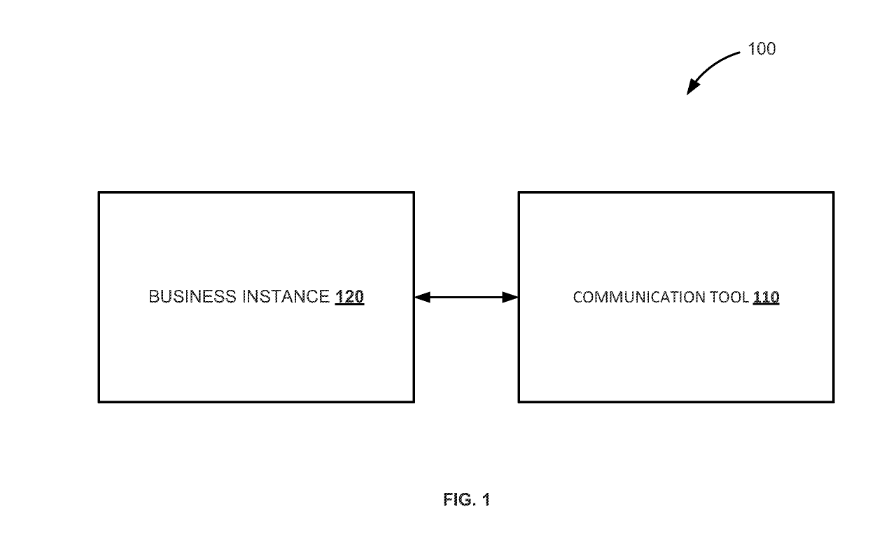

FIG. 1 illustrates one embodiment of a system 100 including a communication tool 110 integrated with a business instance 120. In one embodiment, the integration of the communication tool 110 with the business instance 120 implies that the communication tool 120 is displayed along with the business instance 120 in a same user interface. In one embodiment, the business instance 120 may be one of a business object, a business process, and a business task. In one embodiment, once the business instance 120 is opened or activated, the communication tool 110 retrieves and displays conversation data related to the business instance 120. In one embodiment, the conversation data includes at least one of discussions, discussion thread, queries, and attachments, etc., related to the business instance 120. Therefore, a user analyzing or working on the business instance 120 can simultaneously view all relevant conversations related to the business instance 120. Further, the communication tool 110 enables the user to clarify any query related to the business instance 120 while working on the business instance 120.

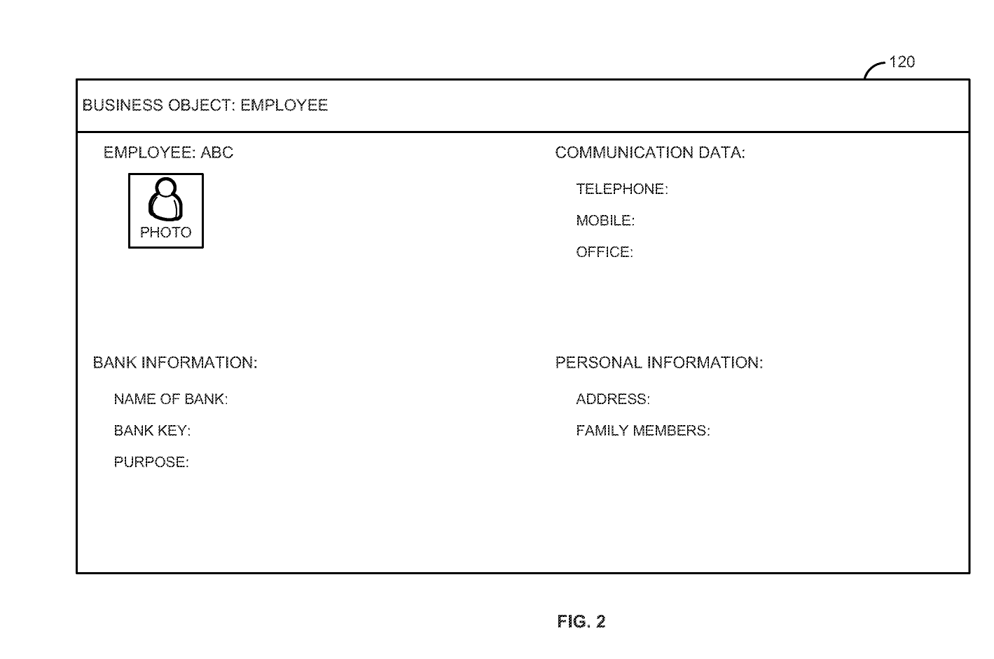

Business instance 120 may be any one of the business object, the business process, or the business task. For example, the business instance 120 may be the business object, e.g., ‘employee,’ as shown in FIG. 2. In one embodiment, the business instance 120 may be the business process such as ‘change working time’ and ‘special bonus payment’ associated with the business object ‘employee.’ In one embodiment, the business instance 120 may be the business task such as ‘request for approving the change in working time,’ ‘approve the change,’ ‘verify the company policies and update a system based upon the change,’ and ‘inform the employee and a manager about the changes,’ etc,, associated with the business process ‘change working time.’ All business instances are part of some business application. For example, the business instance 120 or ‘employee’ may be the part of the business application such as a ‘human capital management (HCM).’

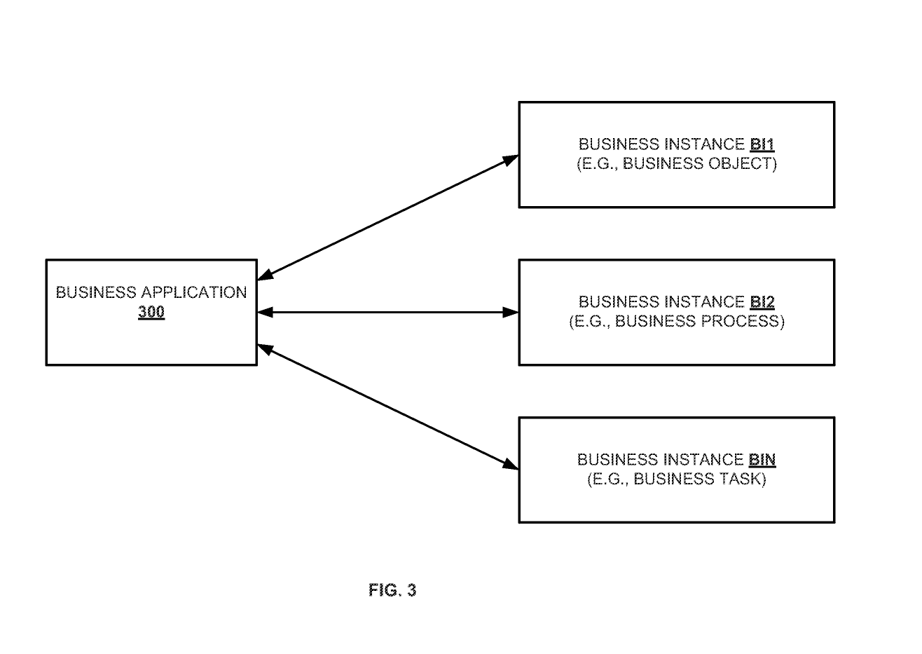

FIG. 3 illustrates a business application 300, as an example, which includes various business instances BI1-BIN. The business instance BI1 may be the business object, the business instance BI2 may be the business process, and the business instance BIN may be the business task, related to the business application 300. In one embodiment, the business application 300 may be any one of the HCM, a customer relationship management (CRM), and an enterprise resource planning (ERP), etc.

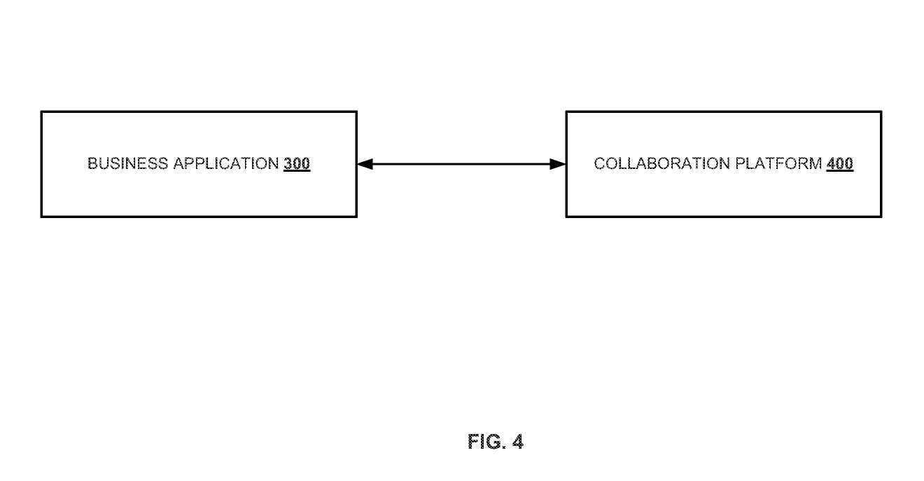

Referring to FIG. 4, the business application 300 is registered with a collaboration platform 400. When the business application 300 is registered with the collaboration platform 400, various instances BI1-BIN of the business application 300 gets integrated with the communication tool 110. For example, the businesses instance BI1 (business Objects) of the application 300 gets integrated with the communication tool 110. In one embodiment, when a system gets registered with the collaboration platform 400 then the applications such as HCM, CRM, and ERP, etc., executing on the system gets automatically registered with the collaboration platform 400. Therefore, once the system is registered with the collaboration platform 400, the applications executing on the system are not required to be individually registered with the collaboration platform 400.

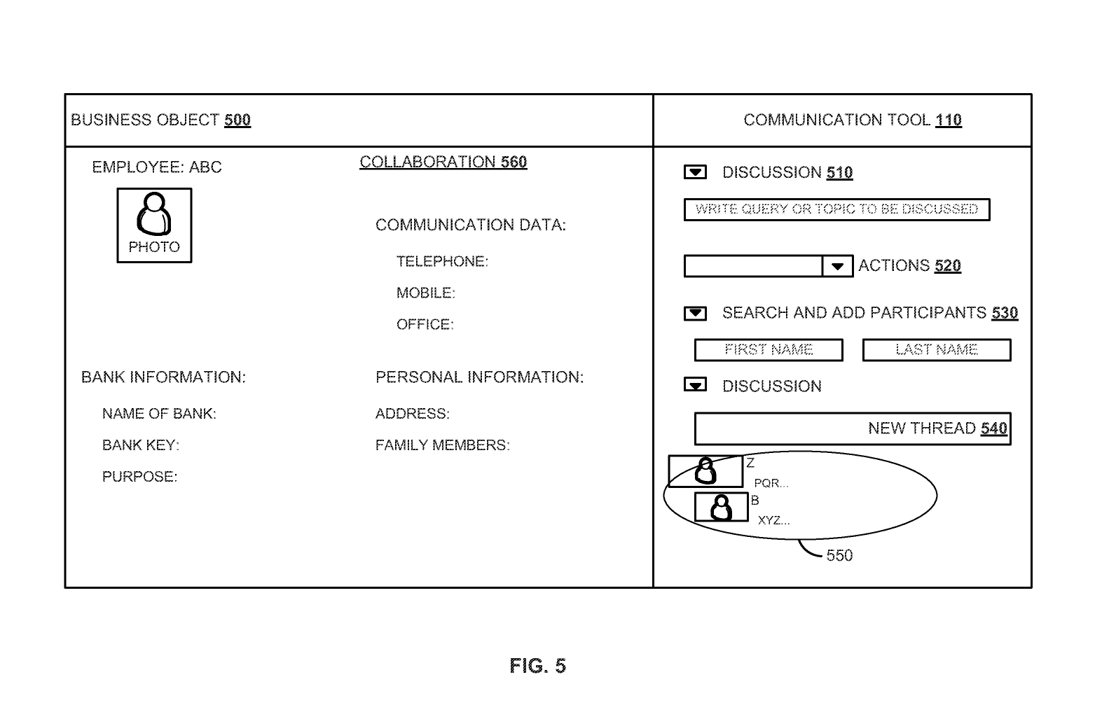

FIG. 5 illustrates the communication tool 110 integrated with a business object 500 namely ‘employee.’ The communication tool 110 and the business object 500 are integrated in that they are displayed on the same user interface. The communication tool 110 retrieves and displays all the prior conversations or discussions (e.g., 550) related to the business object 500. The communication tool 110 comprises a UI element 510 for initiating discussion related to the business object 500. A topic of the discussion or any query related to the business object 500 may be entered by the user to initiate discussion. In one embodiment, a dropdown 520 is provided which is auto populated with all topics which have been discussed. In one embodiment, the dropdown 520 is auto populated with one or more topics of discussion related to the business object 500. For example, the dropdown 520 is auto populated with one or more topics related to business processes (e.g., ‘change working time’ and ‘special bonus,’ etc.) associated with the business object 500. In one aspect, when an option (topic of discussion) from the dropdown 520 is selected, all the discussions related to the selected option or topic will be displayed.

The communication tool also includes a ‘search and add participant’ option 530. Using the ‘search and add participant’ option 530, the user can search and add one or more employees or participants for discussion. Typically, the user can send them invitation to join the discussion and once they accept the invitation, they are included in the discussion. In one embodiment, the communication tool 110 auto suggests various names of participants relevant for the discussion. The users can select the participants of their choice. The communication tool 110 retrieves and displays context specific information (e.g., relevant participants, relevant document, etc) related to the business object 500. The user can select the context specific information. The selected context specific information is integrated or associated with the business object 500. The communication tool 110 also includes a ‘new thread’ option 540. Using the ‘new thread’ option 540, the user can create a new sub topic of discussion under an already created discussion.

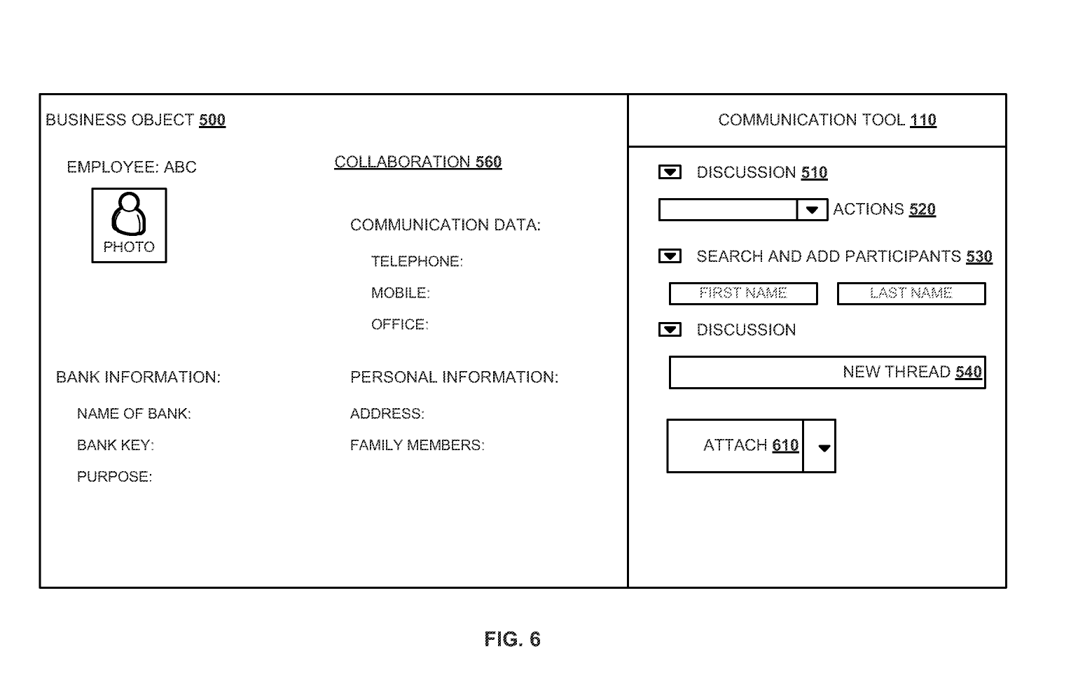

In one embodiment, as shown in FIG. 6, the communication tool 110 also includes an ‘attach’ option 610. Using the attach option 610, the user can attach any information, e.g., a screenshot of the business object 500, and submit the attachment. In one embodiment, once the information is submitted, all participants in the discussion can view the information or the attachment. In one embodiment, the communication tool 110 is displayed upon selecting an icon ‘collaboration’ 560 (FIG. 5).

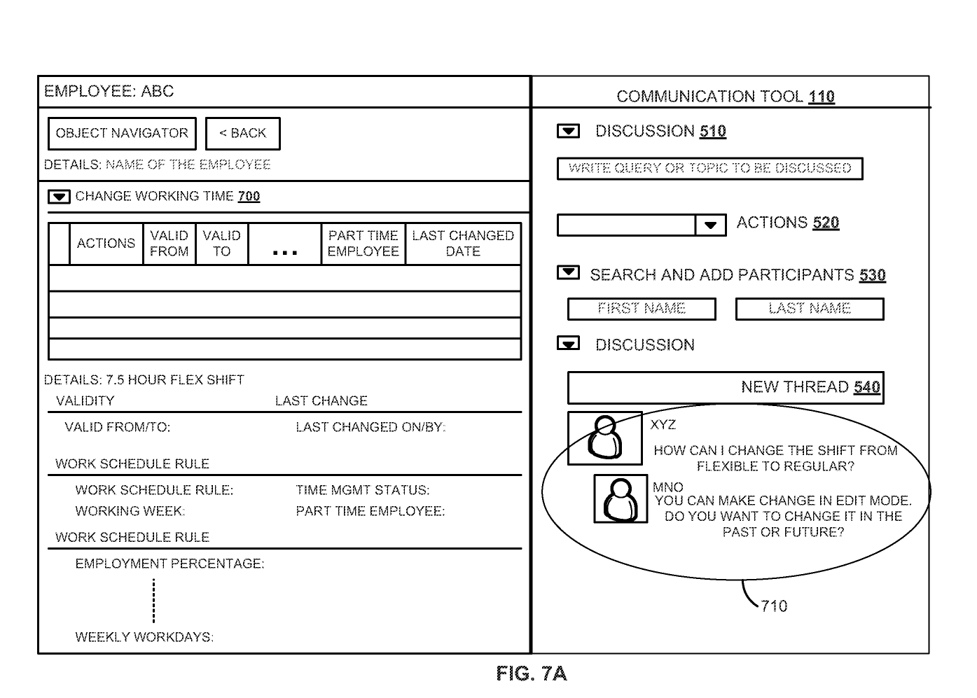

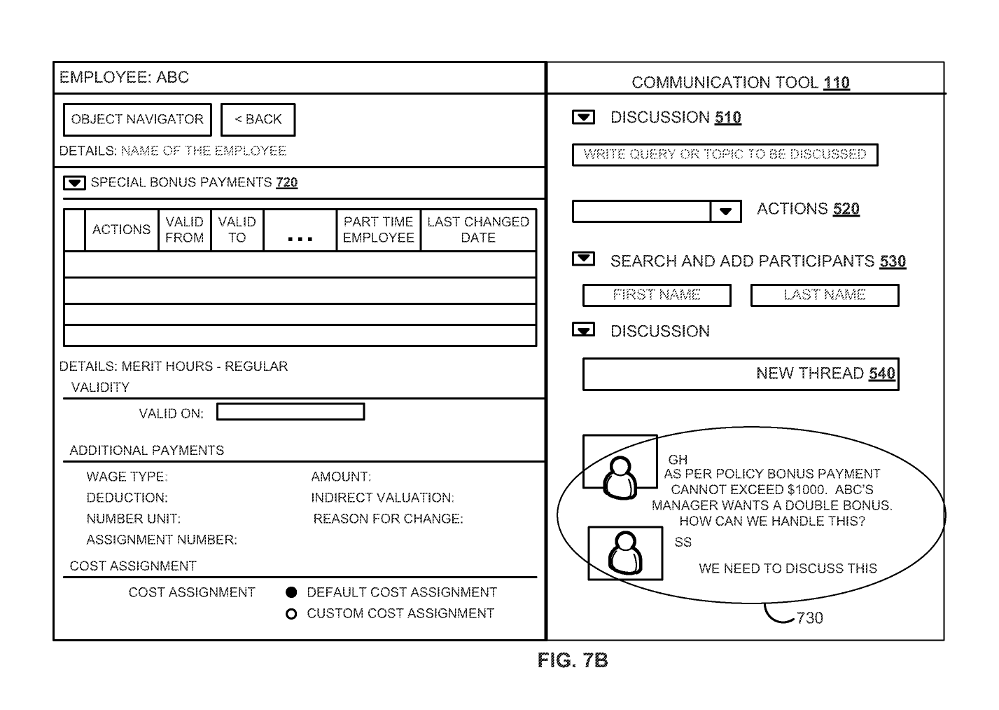

FIGS. 7A and 7B illustrate business process ‘change working time’ 700 and ‘special bonus payment’ 720 associated with the business object 500. As shown, the communication tool 110 integrated with the business process 700 displays the conversation data 710 related to the business process 700 and the communication tool 110 integrated with the business process 720 displays the conversation data 730 related to the business process 720.

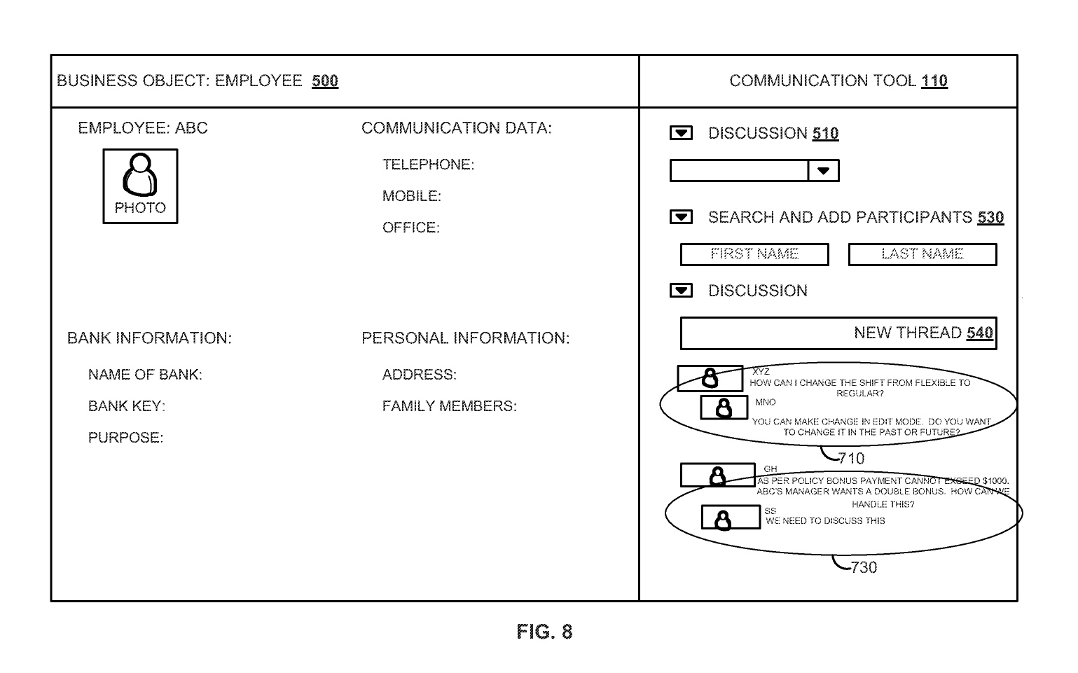

In one embodiment, the communication tool 110 integrated with the business object 500 identifies the business processes 700 and 720 associated with the business object 500. In one embodiment, the communication tool 110 identifies the business processes 700 and 720 associated with the business object 500 from metadata of the business object 500. Once the business processes 700 and 720 are identified, the communication tool 110 retrieves and displays the conversation data 710 and 730 along with the business object 500, as shown in FIG. 8. In one embodiment, the conversation data may be in form of text, audio, video, etc.

Although some features of the communication tool 110 are described above, it should be understood that other features can be easily adopted. Any new feature related to communication may he easily configured within the communication tool 110.

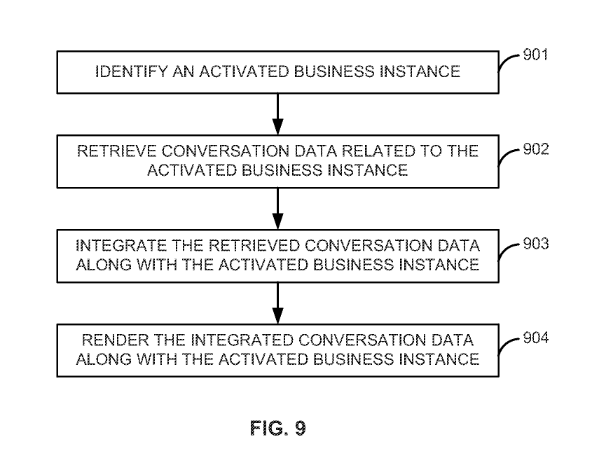

FIG. 9 is a flowchart illustrating a method for rendering conversation data related to the activated business instance, according to an embodiment. The activated business instance is identified at step 901. In one embodiment, the activated business instance is the opened business instance. In one embodiment, the business instance is one of the business object, the business process, and the business task. For example, the activated business instance may be the business object 500. Once the activated business instance (e.g., BO 500) is identified, the communication tool 110 retrieves the conversation data related to the activated business instance at step 902. The retrieved conversation data is integrated with the activated business instance at step 903. The integrated conversation data is then rendered along with the activated business instance at step 904.

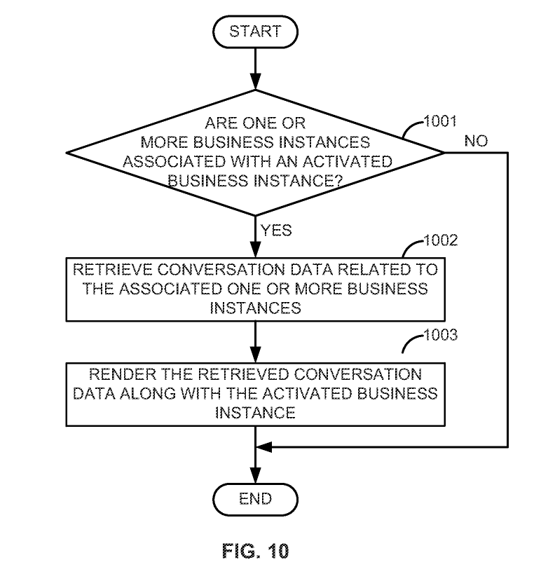

FIG. 10 is a flowchart illustrating a method for rendering conversation data related to business instances associated with the activated business instance, according to an embodiment. The communication tool 110 determines whether one or more business instances are associated with the activated business instance, e.g., 130 500, at step 1001. In one embodiment, the communication tool 110 identifies the business instances associated with the activated business instance from metadata of the activated business instance. In case the one or more business instances (e.g., business processes 700 and 720) are associated with the activated business instance (e.g., BO 500) (step 1001: YES), the communication tool 110 retrieves the conversation data related to the one or more associated business instances at step 1002. For example, the communication tool 110 retrieves conversation data 710 and 730 related to the associated business processes 700 and 720, respectively. At step 1003, the retrieved conversation data 710 and 730 are rendered along with the activated business instance, e.g., the BO 500.

Embodiments described above provide a context-based collaboration. In context-based collaboration, a communication tool is integrated within each business instance itself. For example, the communication tool may be integrated within a business object, a business process, or a business task itself. Therefore, a user while working on the business instance can simultaneously collaborate or clarify queries related to the business instance. Further, all prior communications or conversations related to the business instance are also displayed on the communication tool. Therefore, the user while working on the business instance can easily, conveniently, and efficiently refer to all the relevant communications related to the business instance. It also helps user to focus on the business task without being distracted or switching to various communication channels. Further, it saves time that might get wasted in referring to and aggregating relevant information from various communication channels.

Also, the communication tool automatically suggests relevant information (e.g., relevant participants, relevant documents, etc.) related to the business instance. Therefore, the user can easily refer to or selects the relevant information and can perform the business task efficiently. For example, a human resource (HR) user, performing the business task related to hiring, is automatically suggested the names of relevant consulting agencies to efficiently execute hiring process or to initiate onboarding services. Further, the embodiments also enable auto aggregation of context based information. In auto aggregation of context based information, the communications related to other business instances which are associated with an activated business instance is automatically displayed along with the activated business instance.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of or in combination with machine readable software instructions.

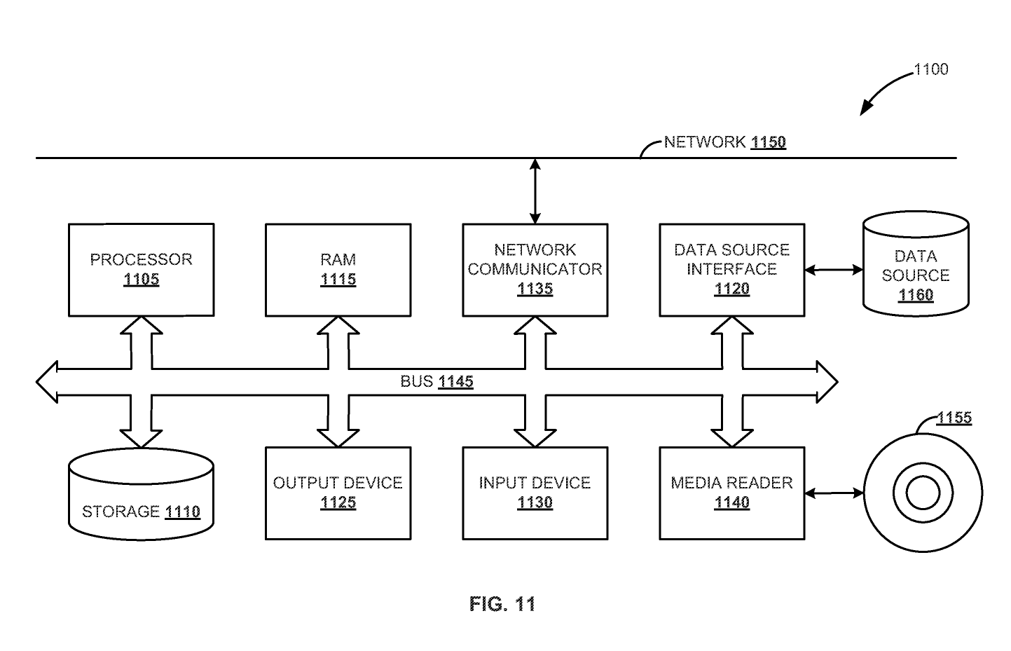

FIG. 11 is a block diagram of an exemplary computer system 1100. The computer system 1100 includes a processor 1105 that executes software instructions or code stored on a computer readable storage medium 1155 to perform the above-illustrated methods. The processor 1105 can include a plurality of cores. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. According to some embodiments, such as some in-memory computing system embodiments, the RAM 1115 can have sufficient storage capacity to store much of the data required for processing in the RAM 1115 instead of in the storage 1110. In some embodiments, all of the data required for processing may be stored in the RAM 1115. The stored instructions may be further compiled to generate other representations of the instructions and dynamically stored in the RAM 1115. The processor 1105 reads instructions from the RAM 1115 and performs actions as instructed. According to one embodiment, the computer system 1100 further includes an output device 1125 (e.g., a display) to provide at least some of the results of the execution as output including, but not limited to, visual information to users and an input device 1130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments are to be determined by the following claims, which are to be interpreted in accordance with established doctrines of claim construction.

What is claimed is:

1. An article of manufacture including a non-transitory computer readable storage medium to tangibly store instructions, which when executed cause one or more computers in a network of computers to:
identify an activated business stance;
retrieve conversation data related to the activated business instance, comprising:
determining one or more business instances associated with the activated business instance; and
retrieving conversation data of the one or more business instances associated with the activated business instance, wherein the conversation data is provided by one or more users via a communication tool integrated with the activated business instance;
integrate the conversation data with the activated business instance; and
render the conversation data and the activated business instance on a user interface.

2. The article of manufacture of claim 1, wherein the one or more business instances are determined from metadata of the activated business instance.

3. The article of manufacture of claim 1 further comprising instructions which when executed cause the one or more computers in the network of computers to:
determine context specific information related to the activated business instance;
render the context specific information for user's selection; and
integrate the selected context specific information with the activated business instance.

4. The article of manufacture of claim 3, wherein the context specific information comprises at least one of a reference of one or more participants and one or more documents.

5. The article of manufacture of claim 1, wherein the business instance comprises at least one of a business object, a business process, and a business task.

6. The article of manufacture of claim 1, wherein the activated business instance comprises an opened business instance.

7. The article of manufacture of claim 1, wherein the conversation data comprises at least one of a discussion, a discussion thread, a query, and an attachment.

8. The article of manufacture of claim 1, wherein the conversation data is in form of at least one of a text data, an audio data, and a video data.

9. A computer-implemented method for contextual collaboration, the method comprising:
identifying an activated business instance including one of a business object, a business process, and a business task;
retrieving conversation data related to the activated business instance, wherein the conversation data is provided by one or more users via a communication tool integrated with the activated business instance;
integrating the conversation data with the activated business instance; and
rendering the conversation data and the activated business instance on a user interface.

10. The method of claim 9, wherein retrieving conversation data related to the activated business instance further comprises:
determining one or more business instances associated with the activated business instance; and
retrieving conversation data of the determined one or more business instances.

11. The method of claim 9 further comprising:
determining context specific information related to the activated business instance;
rendering the context specific information;
receiving a user selection of at least one context specific information from the context specific information; and
integrating the selected at least one context specific information with the activated business instance.

12. A computer system for contextual collaboration. the computer system comprising:
a memory to store program code; and
a processor communicatively coupled to the memory, the processor configured to execute the program code to render a GUI, the GUI comprising:
an activated business instance; and
a communication tool associated with the activated business instance for rendering conversation data related to the activated business instance, the communication tool comprising:
a UI element for enabling a user to perform at least one of initiating a discussion, submitting a query, and submitting a reply;
a UI element for sending invitation to one or more participants for joining the discussion; and
a UI element for enabling the user to attach information related to the activated business instance and to submit the attached information.

13. The computer system of claim 12, wherein the communication tool associated with the activated business instance is rendered in response to a user action.

14. The computer system of claim 12 wherein the communication tool associated with the activated business instance is positioned adjacent to the business instance.

15. The computer system of claim 12, wherein the processor is further configured to execute the program code to:
determine one or more business instances associated with the activated business instance;
retrieve conversation data of the determined one or more business instances; and
render the retrieved conversation data over the communication tool.

16. The computer system of claim 15, wherein the one or more business instances are determined from metadata of the activated business instance.

17. The computer system of claim 12, wherein the processor is further configured to execute the program code to:
determine context specific information related to the activated business instance;
render the context specific information over the communication tool;
receive a user selection of a context specific information from the rendered context specific information; and
integrate the selected context specific information with the activated business instance.

18. The computer system of claim 12, wherein the activated business instance comprises an opened business instance.

19. The computer system of claim 12, wherein the conversation data comprises at least one of a discussion, a discussion thread, a query, and an attachment.

20. The computer system of claim 12, wherein the conversation data is in form of at least one of a text data, an audio data, and a video data.
